(19) United States
(12) Patent Application Publication
(10) Pub. No.: US 2013/0344790 A1
(43) Pub. Date: Dec. 26, 2013

(54) AIR CYCLE MACHINE FOR AN ENVIRONMENTAL CONTROL SYSTEM

(71) Applicants: Donald E. Army, Enfield, CT (US); Patrick Michael McCord, Norwich, CT (US)

(72) Inventors: Donald E. Army, Enfield, CT (US); Patrick Michael McCord, Norwich, CT (US)

(73) Assignee: HAMILTON SUNDSTRAND CORPORATION, Windsor Locks, CT (US)

(21) Appl. No.: 13/528,002

(22) Filed: Jun. 20, 2012

(51) Int. Cl. B60H 1/34; B23P 17/04

(52) U.S. Cl. 454/152; 454/284; 29/428

(57) ABSTRACT

An air cycle machine (ACM) for an environmental control system (ECS) includes a diffuser formed of a single, unitary component and having a first end and a second end, wherein the diffuser is disposed, and operably coupled to, a first component proximate the first end and to a second component proximate the second end. Also included is a mounting support integrally formed with the diffuser for fixedly retaining at least one trim duct proximate the diffuser. Further included is a mounting attachment integrally formed with the diffuser for supporting a pack wiring harness.

### BACKGROUND OF THE INVENTION

The present invention relates to environmental control systems, and more particularly to an air cycle machine diffuser of the environmental control system.

Environmental control systems (ECS) are utilized on various types of aircraft for several purposes, such as air supply systems and/or cabin conditioning systems for the aircraft. For example, components of the ECS may be utilized to remove heat from various aircraft lubrication and electrical systems and/or used to condition aircraft cabin air. The cabin air conditioner includes one or more cabin air compressors (CACs) which compress air entering the system from an outside source or from a ram air system. The compressed air is delivered to an air cycle machine (ACM) to bring it to a desired temperature and then delivered to the aircraft cabin. After passing through the cabin, the air is typically exhausted to the outside or recirculated for further use.

The ACM includes, among several other components, a mixing component that is mounted to a variety of ACM components. The mixing component typically comprises a plurality of pieces requiring assembly during installation to the ACM generally, and specifically the variety of ACM components. Although adequate, the multi-piece mixing component results in inefficient and/or undesirable installation procedures.

### BRIEF DESCRIPTION OF THE INVENTION

According to one embodiment, an air cycle machine (ACM) for an environmental control system (ECS) includes a diffuser formed of a single, unitary component and having a first end and a second end, wherein the diffuser is disposed, and operably coupled to, a first component proximate the first end and to a second component proximate the second end. Also included is a mounting support integrally formed with the diffuser for fixedly retaining at least one trim duct proximate the diffuser. Further included is a mounting attachment integrally formed with the diffuser for supporting a pack wiring harness.

According to another embodiment, a method for assembling an air cycle machine (ACM) is provided. The method includes positioning a first end of a single, unitary diffuser proximate a first component of the ACM. Also included is positioning a second end of the single, unitary diffuser proximate a second component of the ACM. Further included is operably coupling the first end to the first component. Yet further included is operably coupling the second end to the second component. Also included is mounting at least one trim duct to a mounting support integrally formed with the single, unitary diffuser.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a perspective view of an environmental control system having a first section and a second section;

FIG. 2 is a top plan view of the first section of the environmental control system;

FIG. 3 is an enlarged perspective view section III of FIG. 2;

FIG. 4 is a perspective view of a diffuser of the first section of the environmental control system;

FIG. 5 is a side, elevational view of the diffuser;

FIG. 6 is an end view of the diffuser;

FIG. 7 is a bottom plan view of the diffuser;

FIG. 8 is a side, elevational view of the diffuser illustrating a connection to a first component;

FIG. 9 is a cross-sectional view of a first end of the diffuser connected to the first component taken along line IX-IX of FIG. 8; and

FIG. 10 is a flow diagram illustrating a method for assembling an air cycle machine of the environmental control system.

### DETAILED DESCRIPTION OF THE INVENTION

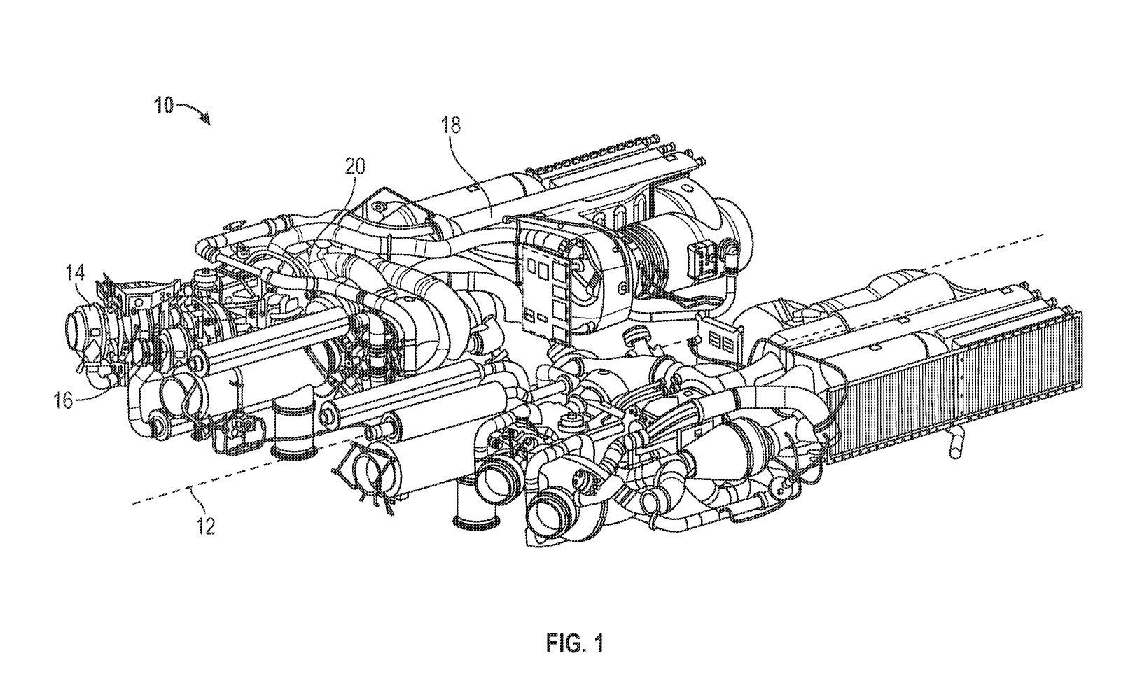

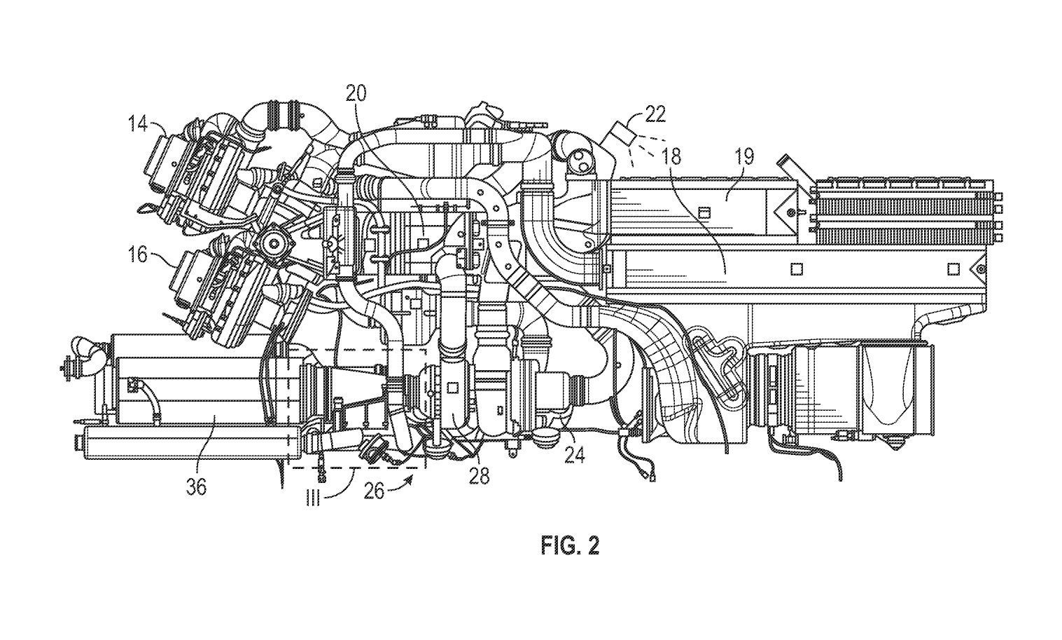

Referring to FIGS. 1 and 2, an environmental control system (ECS) is illustrated and referred to with numeral 10. The ECS 10 is configured to condition air for various environments, such as an aircraft cabin. It is envisioned, however, that the ECS 10 may be used to condition numerous other environments and is not limited to use in the aircraft context.

The illustrated ECS 10 typically includes a pair of corresponding structures disposed symmetrically about an axial centerline 12, with both structures comprising similar components and performing similar functions. For simplicity and with reference to FIG. 2 in particular, only one of the structures will be described in detail.

The ECS includes at least one, but typically a plurality of cabin air compressors (CACs), such as a first CAC 14 and a second CAC 16, to compress and heat air entering the ECS 10 from an outside source or from a ram air system. The heated air is routed to a primary heat exchanger 18, where the air is cooled therein. The air is then routed to a compressor section (not labeled) of an air cycle machine (ACM) 26, then to a secondary heat exchanger 19, and subsequently to a condenser section 20, where the air is further cooled below its dew point. Water particles are formed within the condenser section 20, with the water particles being removed from the system and injected into a ram air system 22. Removal of the water particles in the condenser section 20 results in a relatively dried airflow that is transferred to a turbine inlet of a first stage turbine 24 of the ACM 26. It is contemplated that a second stage turbine 28 is also disposed downstream of the first stage turbine 24.

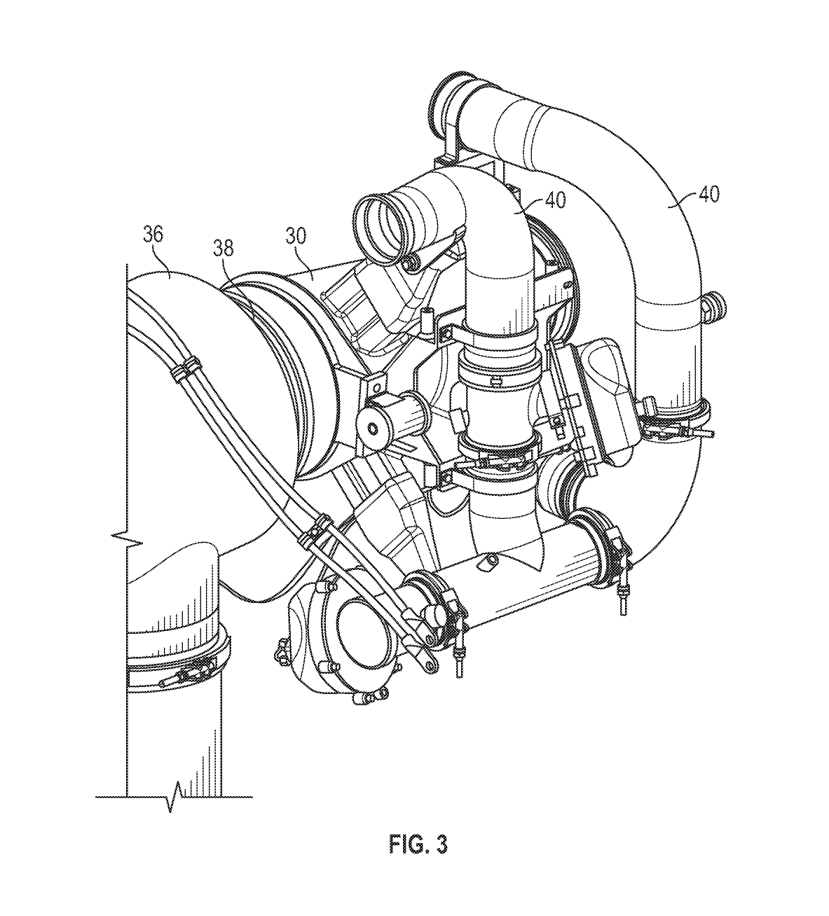

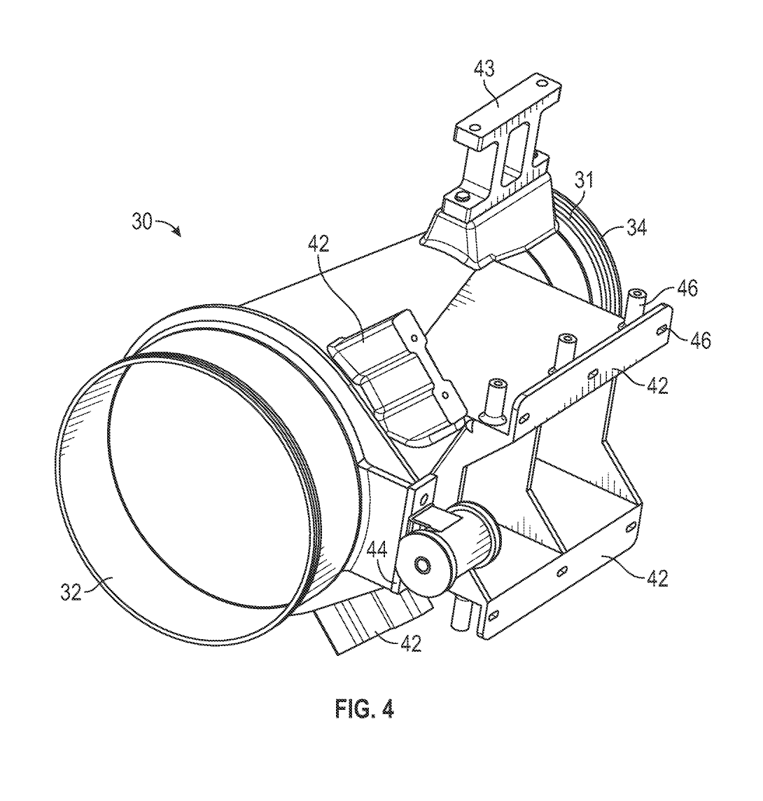

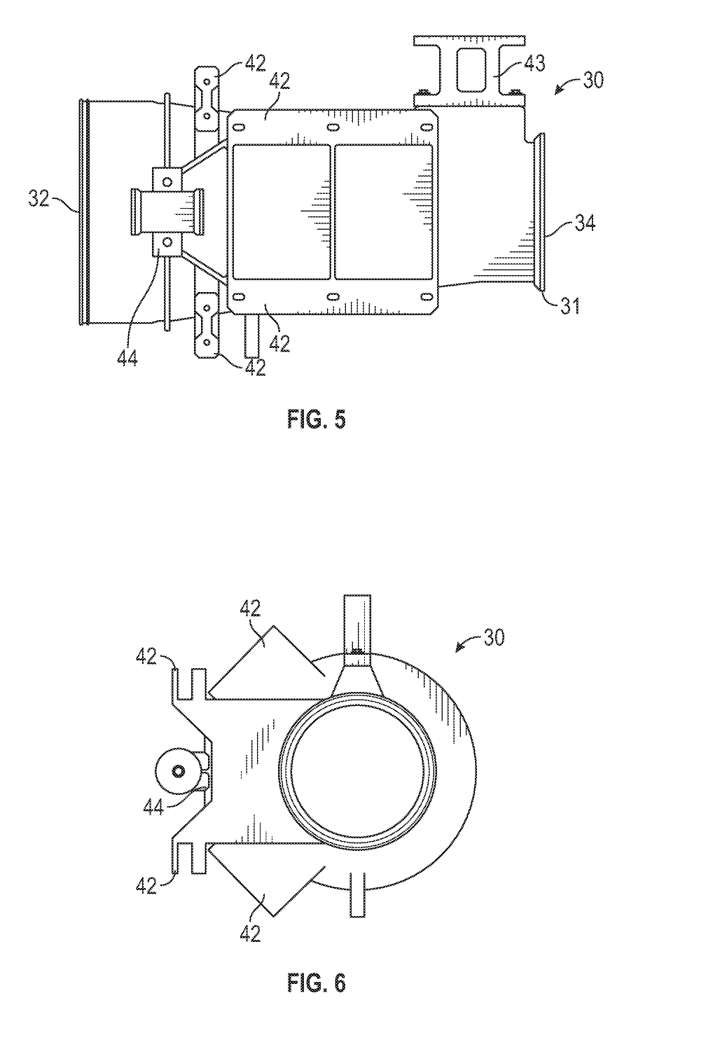

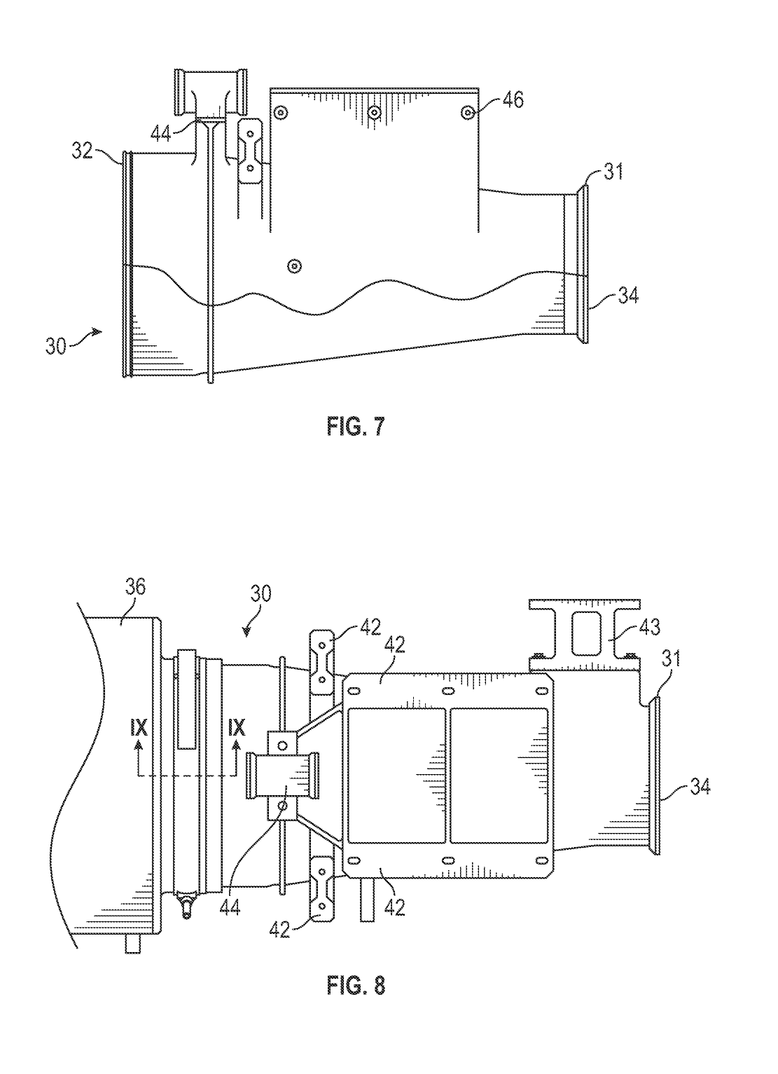

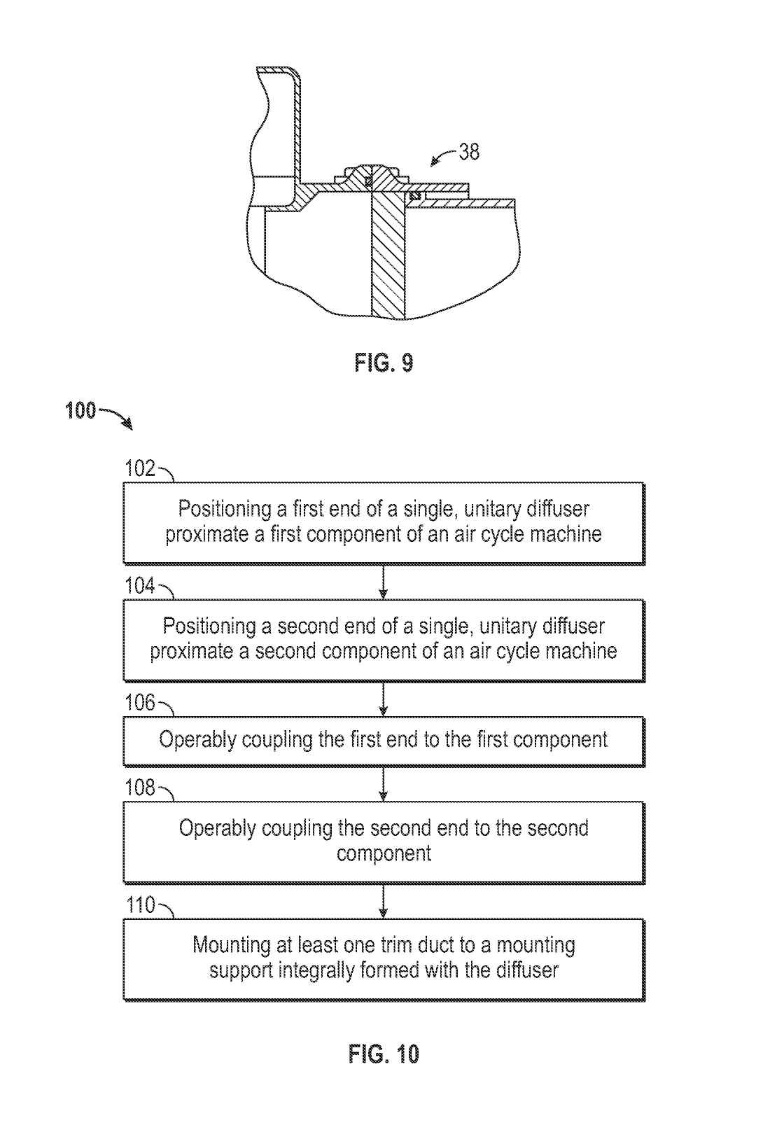

Referring now to FIGS. 3-9, irrespective of the number of turbine stages, a diffuser 30 formed of a single, unitary structure is disposed proximate an outlet of the first stage turbine 24 or the second stage turbine 28 (or proximate another stage if more than two are present) and is of a substantially conical geometry, expanding from an upstream region to a downstream region. A V-band coupling 31 is disposed between the diffuser 30 and an outlet of the second stage turbine 28. The diffuser 30 may be formed in a variety of processes, including a casting process or from a composite construction, for example. The preceding examples are merely illustrative and it is to be appreciated that various other suitable formation processes are contemplated. As noted above, the diffuser 30 is a single, unitary structure pre-formed prior to installation within the ECS 10 and more specifically the ACM 26. The diffuser 30 includes a first end 32 and a second end 34, with the first end 32 disposed proximate, and operably coupled to, a muffler 36 that is configured to receive exhaust airflow from the diffuser 30. A slip joint 38 may be disposed immediately adjacent the first end 32 of the diffuser 30 and the muffler 36 for operably joining the diffuser 30 and the muffler 36. The slip joint 38 provides the ability to allow the muffler 36 to be retracted towards the ACM 26 for pack installation into the aircraft. It also allows the diffuser 30 to be retracted away from the ACM 26 during replacement. The second end 34 is disposed proximate, and operably coupled to, the second stage turbine 28. The airflow is distributed at various minimum temperatures that are a function of altitude. The minimum temperature varies from about 29° F. (about −2° C.) to about 37° F. (about 3° C.). The distributed air is then ready for cabin conditioning when needed.

The diffuser includes at least one trim duct 40 that is mounted to, and fixedly retained to, the diffuser 30 by a mounting support interface 42, such as a bracket, that is integrally formed with the single, unitary structure of the diffuser 30. Additional supports for the at least one trim duct 40 include one or more bolt-on brackets 43 The diffuser 30 also includes a pack mounting interface 44 to facilitate mounting of the ECS 10 to adjacent structure(s). The pack mounting interface comprises a tie-rod mounting bracket that is configured to fixedly retain a tie-rod integrated with a tile (not illustrated). Additionally, the diffuser 30 includes at least one, but typically a plurality of mounting attachments 46 for connecting to and supporting one or more pack wiring harnesses.

A method for assembling 100 the ACM 26 is also provided as illustrated in FIG. 10 and with reference to FIGS. 1-9. The ACM 26 and more generally the ECS 10 have been previously described and specific structural components need not be described in further detail. The method for assembling 100 includes positioning a first end of a single, unitary diffuser 102 proximate a first component of the ACM, where the first component is the muffler 36, as described above. A second end of the diffuser is positioned 104 proximate a second component of the ACM, where the second component is a turbine stage outlet, such as the above-described second stage turbine 28. The first end is operably coupled to the first component 106, while the second end is operably coupled to the second component 108. At least one trim duct is mounted 110 to a mounting support integrally formed with the diffuser 30 for supplying recirculated air from the aircraft cabin to be mixed with the exhaust airflow supplied from the second stage turbine 28.

Advantageously, the single, unitary construction of the diffuser 30 reduces the complexity associated with an installation process, when compared to a multi-piece construction. The diffuser 30 integrates a variety of structural components that facilitate installation and function to interact with numerous other components of the ACM 26, and more generally the ECS 10.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An air cycle machine (ACM) for an environmental control system (ECS) comprising:
a diffuser formed of a single, unitary component and having a first end and a second end, wherein the diffuser is disposed, and operably coupled to, a first component proximate the first end and to a second component proximate the second end;
a mounting support integrally formed with the diffuser for fixedly retaining at least one trim duct proximate the diffuser; and
a mounting attachment integrally formed with the diffuser for supporting a pack wiring harness.

2. The ACM of claim 1, further comprising a slip joint configured to provide retraction of the ACM during installation of the ACM.

3. The ACM of claim 1, wherein the first component is a muffler.

4. The ACM of claim 1, wherein the second component is a turbine outlet.

5. The ACM of claim 1, wherein the diffuser is formed from a casting process.

6. The ACM of claim 1, wherein the diffuser is formed from a composite construction.

7. The ACM of claim 1, wherein the diffuser receives a cooled airflow for distribution to an aircraft cabin.

8. A method for assembling an air cycle machine (ACM) comprising:
positioning a first end of a single, unitary diffuser proximate a first component of the ACM;
positioning a second end of the single, unitary diffuser proximate a second component of the ACM;
operably coupling the first end to the first component;
operably coupling the second end to the second component; and
mounting at least one trim duct to a mounting support integrally formed with the single, unitary diffuser.

9. The method of claim 8, wherein the first component is a muffler.

10. The method of claim 8, wherein the second component is a turbine.

11. The method of claim 9, further comprising disposing a slip joint proximate the first component, wherein the slip joint is configured to allow the muffler to retract towards the ACM during installation and the diffuser to retract away from the ACM during replacement of the ACM.

12. The method of claim 8, wherein the diffuser is formed from a casting process.

13. The method of claim 8, wherein the diffuser is formed from a composite construction.

14. The method of claim 8, wherein the diffuser is configured to receive an cooled airflow for distribution to an aircraft cabin.

15. The method of claim 8, further comprising mounting at least one pack wiring harness to a mounting attachment integrally formed with the diffuser.

16. The method of claim 8, further comprising mounting the ACM to an adjacent structure through a pack mounting attachment.

17. The method of claim 16, wherein the pack mounting attachment comprises a tie-rod bracket configured to fixedly connect to a tie-rod.
